(19) United States
(12) Patent Application Publication
(10) Pub. No.: US 2020/0085031 A1
(43) Pub. Date: Mar. 19, 2020

(54) MODULAR ELEMENT OF AN ARM OF A SPRAY BAR

(71) Applicant: POMMIER - SCEBP, Eole-En-Beauce (FR)

(72) Inventors: Frédéric LASNE, Mesnay-Le-Vidame (FR); Nicolas POMMIER, Eole-En-Beauce (FR)

(73) Assignee: POMMIER - SCEBP, Eole-En-Beauce (FR)

(21) Appl. No.: 16/570,033

(22) Filed: Sep. 13, 2019

(30) Foreign Application Priority Data
Sep. 13, 2018 (FR) 1858245

(51) Int. Cl. A01M 7/00

(52) U.S. Cl. CPC A01M 7/0071; A01M 7/006

(57) ABSTRACT

A modular element for the manufacturing of an arm or of an arm segment of a spray bar provided with spray nozzles, including a first profile determining a longitudinal housing open downwards and at each of its longitudinal ends. A reinforcement is disposed above the first profile in such a way that the respective longitudinal axes of the reinforcement and of the first profile belong to the vertical plane P of longitudinal symmetry of said modular element. A plurality of stiffeners longitudinally connect at least the first profile and the reinforcement to each other, and two plates are disposed at one of the longitudinal ends of said first profile and laterally connect at least the longitudinal ends of the first profile and of the reinforcement to each other.

### TECHNICAL FIELD

The present invention relates to the general field of agriculture. It is aimed more precisely at a modular element for the manufacturing of an arm or arm segment of an agricultural spray bar, as well as a bar for spraying or spreading of granules or liquid made from a plurality of modular elements.

### BACKGROUND

In the field of agriculture, it is known to treat plant cultures in order to combat insects, diseases or weeds, in order to guarantee a good yield of the operation.

To do this, a sprayer, is conventionally used, carried or pulled by a tractor, or self-propelled, and comprising at least:
a tank containing the liquid spray mixture coming from the mixture of phytosanitary product and water,
a bar comprising two arms articulated on either side of said tank, each provided with a plurality of segments capable of being folded onto themselves during the movement of the sprayer on a road, and supporting spray nozzles and depending on the size of the operation and the relief of the terrain, and
a pump pressurizing the spray mixture contained in the tank and sucking up the latter in order to send it to the bar and the nozzles, said pump ensuring a homogenous mixture of the spray mixture in order for its concentration to be identical from the beginning to the end of the spraying.

One of the main disadvantages of the sprayers is related to the manufacturing of the arms and of their segments. Indeed, the latter must satisfy the following constraints:
having a structure with significant mechanical strength in particular for the arms and segments having a large width,
receiving the spraying equipment (piping, nozzle holders, fastening lugs) and protecting it from collisions or from snagging on the plant cultures to be treated,
allowing the installation of the spray nozzles without interference with said structure and according to a regular spacing in order to guarantee homogenous spraying of the spray mixture.

Moreover, these arms and segments are made from numerous elements which are conventionally extruded profiles, positioned on a template and then welded to each other.

This manufacturing, which requires the manufacturing of numerous welding templates, is long and costly and does not really allow to industrialize the manufacturing of these arms and these segments.

Finally, according to the country of use of these bars and/or the manufacturers of the spray nozzles, the spacing between the latter is variable and thus requires a specific dimensioning of the structure for each spacing.

### SUMMARY

The goal of the present invention is to propose a modular element allowing to manufacture arms of a spray bar or segments of arms while guaranteeing significant mechanical strength regardless of their width, while reducing the number of component parts to be welded to each other, and while allowing the installation of the spray nozzles without interference with said structure, regardless of their spacing.

According to the invention, a modular element is therefore proposed, for the manufacturing of an arm or of an arm segment of a spray bar provided with spray nozzles, remarkable in that it comprises at least:
a first profile determining a longitudinal housing open downwards and at each of its longitudinal ends, the first profile and the housing being configured to entirely receive the spray nozzles and pipings connecting them to each other,
a reinforcement disposed above the first profile in such a way that the axes that are longitudinal and of the first profile belong to the plane P longitudinal symmetry of said modular element,
a plurality of stiffeners longitudinally connecting at least the first profile and the reinforcement to each other, and
two plates each disposed at one of the longitudinal ends of said first profile and laterally connecting at least the longitudinal ends of the first profile and of the reinforcement to each other.

The modular element advantageously comprises a second profile disposed above the reinforcement in such a way that its longitudinal axis belongs to said vertical plane P, said reinforcements longitudinally connecting the first profile, the reinforcement and the second profile to each other, and said plates laterally connecting the longitudinal ends of the first profile, of the reinforcement and of the second profile to each other.

According to an advantageous embodiment, the first profile has a transverse cross-section in the overall shape of a C pivoted by 90° and comprises a substantially horizontal core, two flanges coming from the longitudinal edges of said core and extending downwards, and two lips each coming from the lower longitudinal edges of said flanges and extending substantially horizontally towards the inside of said flanges while facing each other.

The first and second profiles are advantageously perforated and respectively comprise a plurality of holes.

The reinforcement preferably has a transverse cross-section having a generally circular shape and is hollow tubular opening at each of its longitudinal ends.

The reinforcement advantageously comprises an orifice made under said reinforcement.

According to an advantageous embodiment, each plate comprises a plurality of piercings and determines two flat faces parallel to each other and offset with respect to one another and an inclined median face connecting the two flat faces to each other, said plates having a complementary shape.

The component elements of the modular element preferably comprise a plurality of orifices.

The invention also relates to a method for manufacturing a modular element according to the invention remarkable in that the following is carried out:
manufacturing of the component elements of the element,
preassembly of said component elements using bolts put in place in the orifices,
welding of said component elements of the element to each other.

Finally, the invention also relates to an arm or an arm segment of a spray bar remarkable in that it is manufactured from at least one modular element according to the invention.

### BRIEF DESCRIPTION OF THE DRAWINGS

Other advantages and features will be clearer from the following description of a mode of execution of a modular element according to the invention in reference to the appended drawings in which:

FIG. 1 is a perspective view of a modular element according to the invention;

FIG. 2 is a side view of the element of FIG. 1;

FIG. 3 is an enlarged vertical cross-section of the element of FIG. 1;

FIG. 4 is a partial perspective view of the element of FIG. 1 with spray nozzles;

FIG. 5 is an exploded perspective view of an arm segment made from elements similar to that of FIG. 1;

FIG. 6 is a perspective view of the arm segment of FIG. 4;

FIG. 7 is a perspective view of the arm made from the segment of FIGS. 5 and 6;

FIG. 8 is an enlarged detailed view of the arm of FIG. 7.

### DETAILED DESCRIPTION

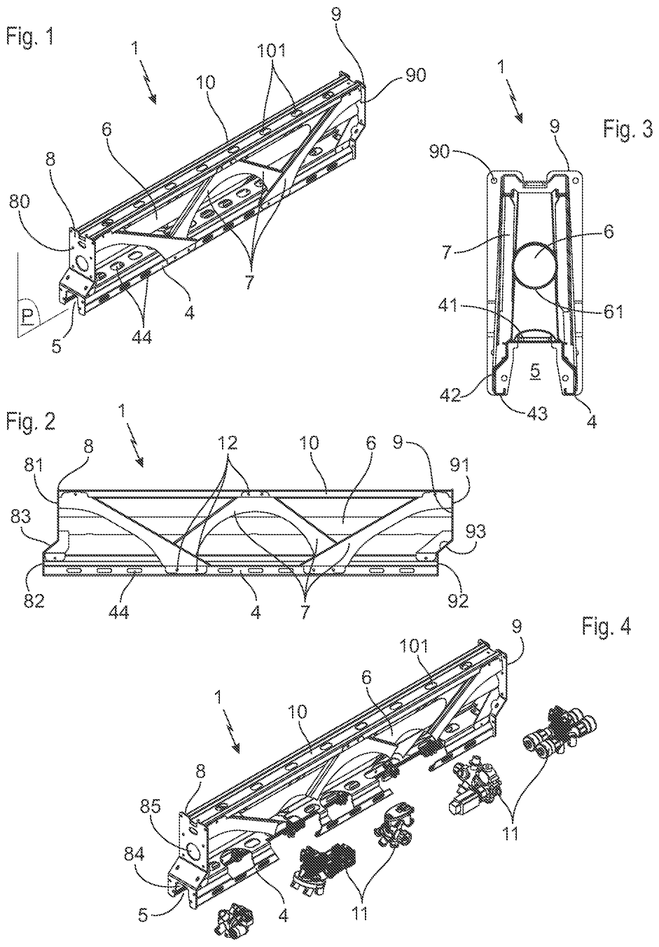

In reference to FIGS. 1 to 7, the invention relates to a modular element 1 for the manufacturing of an arm 2 or of an arm 2 segment 3 of a bar for spraying or spreading of granules or liquid.

Each modular element 1 comprises at least:
a first profile 4 defining a longitudinal housing 5 open downwards and at each of the longitudinal ends of said first profile 4,
a reinforcement 6 disposed above the first profile 4 in such a way that the respective longitudinal axes of the reinforcement 6 and of the first profile 4 belong to the vertical plane P of longitudinal symmetry of said modular element 1 (Cf. FIG. 1),
a plurality of stiffeners 7 longitudinally connecting at least the first profile 4 and the reinforcement 6 to each other, and
two plates 8,9 each disposed at one of the longitudinal ends of said first profile 4 and laterally connecting at least the longitudinal ends of the first profile 4 and of the reinforcement 6 to each other.

According to an advantageous embodiment, in particular for the most mechanically stressed segments, the modular element 1 according to the invention further comprises a second profile 10 disposed above the reinforcement 6 in such a way that its longitudinal axis belongs to said vertical plane P. In this hypothesis, the stiffeners 7 longitudinally connect not only the first profile 4 and the reinforcement 6 to each other, but also the second profile 10. Likewise, the plates 8,9 laterally connect not only the longitudinal ends of the first profile 4 and of the reinforcement 6 to each other, but also the longitudinal ends of the second profile 10.

The first profile 4 advantageously has a transverse cross-section in the overall shape of a C pivoted by 90° and comprises at least one substantially horizontal core 41, two flanges 42 coming from the longitudinal edges of said core 41 and extending downwards, and two lips 43 each coming from the lower longitudinal edges of said flanges 42 and extending substantially horizontally towards the inside of said flanges 42 while facing each other (Cf. FIG. 3).

The first profile 4 can have a transverse cross-section in the overall shape of a U or a V pivoted by 180° without going beyond the context of the present invention.

The first profile 4 and the housing 5 are configured to entirely receive the spray nozzles 11 and the pipings, not shown, connecting the nozzles 11 to each other (Cf. FIG. 4).

Here, a modular element 1 for the manufacturing of an arm 2 or of an arm 2 segment 3 of a spray bar is described.

However, the modular element 1 can be used to manufacture an arm or an arm segment of a bar for spreading granules or liquid. In this case, it is indeed understood that the nozzles would obviously be replaced by systems for spreading granules or liquid, and the first profile and the housing of the modular element would thus be configured to entirely receive said spreading systems and the associated pipings.

Here, “entirely receive” means the fact that once in place in the housing 5 the spray nozzles 11—pipings assembly does not protrude from the first profile 4.

It is indeed understood that with a housing 5 freeing a space over the entire length of the modular element 1, the spray nozzles 11 are installed in said housing 5 without interference with the structure of said modular element 1, regardless of the spacing between the nozzles 11.

Moreover, it is indeed understood that once in place in said housing 5, the spray nozzles 11 are perfectly protected from collisions with or from snagging on the plant cultures to be treated, by the first profile 4 and in particular by its flanges 42 and its lips 43.

For obvious reasons of lightness, the first and second profiles 4,10 are advantageously perforated and respectively comprise a plurality of holes 44,101.

For reasons of mechanical strength, in particular with respect to twisting during the operations of unfolding/folding of the segments 3, the reinforcement 6 advantageously has a transverse cross-section having a generally circular shape.

“Generally circular” means the fact that the reinforcement 6 comprises a transverse cross-section that can be totally or partially in the shape of a circle, an ellipse or a closed plane curve not comprising a sharp right angle.

Moreover for reasons of lightness, the reinforcement 6 is hollow tubular opening at each of its longitudinal ends. This configuration further allows to pass, inside said reinforcement 6, at least one pipe for supplying a treatment product coming from a tank, not shown. The connection between this supply pipe and the spray nozzles 11 disposed in said housing 5 of the modular element 1 is thus carried out by at least one connecting pipe, not shown, simultaneously passing through one of the holes 44 made on the core 41 of said first profile 4 and an orifice 61 made under said reinforcement 6, and being connected to the supply pipe and to the spray nozzles 11—pipings assembly.

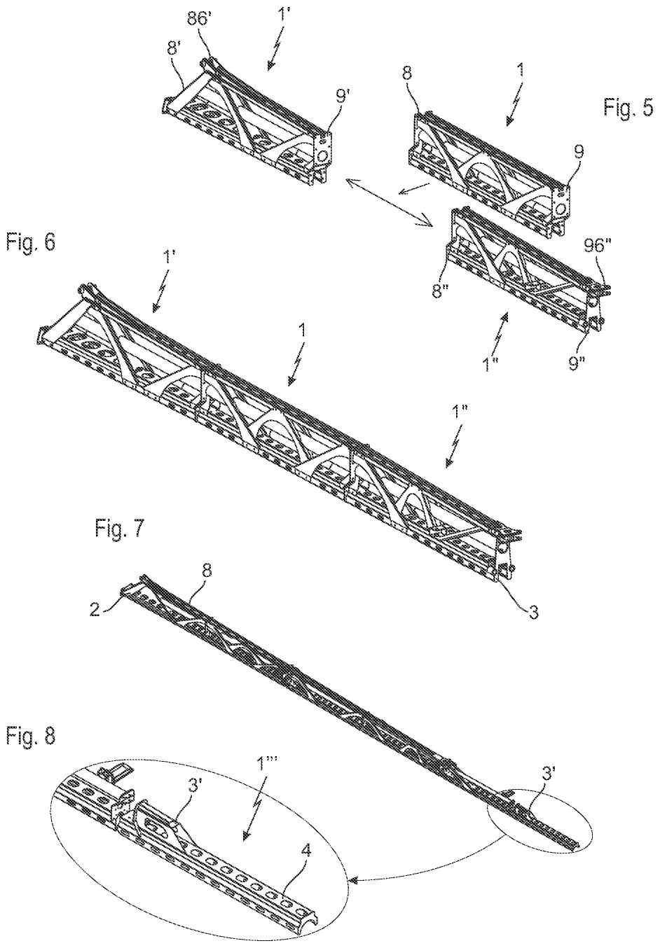

The plates 8,9 are configured to allow to assemble the modular element 1 by its plate 8 with adjacent similar modular elements 1′,1″ respectively by their plate 9′ and 8″ in order to form a segment 3 of an arm 2 of a spray bar (Cf. FIGS. 5 to 7).

Each plate 8,9,8″,9′ comprises a plurality of piercings 80,90 allowing to install bolts, not shown, in order to press the plates 8,9,8″,9′ against each other in order to ensure the assembly of the modular element 1 with the adjacent similar modular elements 1′,1″.

For reasons of mechanical strength, the plates 8,9 have a complementary shape and each plate 8,9 preferably determines two flat faces 81,82; 91,92 parallel to each other and offset with respect to one another, and an inclined median face 83;93 connecting the two flat faces 81,82; 91,92 to each other. This configuration allows to avoid all of the mechanical stresses being taken up only by the assembly bolts.

Moreover, each plate 8,9 comprises a lower cutout 84 in order to not close the longitudinal ends of the first profile and allow the installation of the assembly nozzles 11 of .spraying—pipings.

Likewise, in the hypothesis in which the reinforcement 6 is hollow tubular opening at each of its longitudinal ends, each plate 8,9 comprises a hole 85 in order to not close the longitudinal ends of said reinforcement 6 (Cf. FIG. 4).

Moreover, in reference to FIG. 5, it is indeed understood that in order to allow the unfolding/folding of the segments 3 and/or of the arms 2, the respective plates 8′,9″ of the modular elements 1′,1″ located at the longitudinal ends of the segment 3 can be different than those described above and can comprise at least portions 86′,96″ of articulations.

A Person Skilled in the Art would have no difficulty designing said articulations and portions 86′,96″.

The component elements of the modular element 1 (namely the first profile 4, the reinforcement 6, the stiffeners 7, the two plates 8,9 and, if necessary, the second profile 10) are advantageously metal parts, preferably made of aluminum, obtained by cutting, folding, drawing or even extrusion.

These component elements of the modular element 1 comprise a plurality of orifices 12 capable of receiving bolts, not shown, in order to assemble them before the operation of welding in order to avoid manufacturing and using welding templates.

Thus, in order to manufacture a modular element 1 according to the invention, the following is carried out:
manufacturing of the component elements of the element 1,
preassembly of said component elements using bolts put in place in the orifices 12,
welding of said component elements of the element 1 to each other,
optional removal of the bolts after welding.

It is indeed understood that the step of preassembly by bolts allows direct passage to the welding without use of a template, nor of a step of boring and thus an automation of the welding step.

Moreover, with the configuration described, the modular element 1 according to the invention is symmetrical, and can be used to manufacture a segment 3 of the right or left arm 2 of a spray bar.

Moreover, an arm comprising three segments has been described here, each segment being composed of two or three modular elements. However, it goes without saying that the number of segments per arm and the number of modular elements per segment can vary without going beyond the context of the present invention.

Finally, in reference to FIGS. 7 and 8, it is indeed understood that the modular element 1′″ forming the segment 3′ located at the free end of the arm 2 is much less stressed that the other segments. Consequently, this modular element 1′″ is advantageously lightened in order to limit its cost. Thus, it can comprise only the first profile 4.

The modular element 1 according to the invention applies to the creation of arms or arm segments of any type of bar for spraying or spreading and not only spray bars made of aluminum.

Finally, it goes without saying that the examples of modular elements 1 according to the invention that have just been described are only specific illustrations, in no case limiting to the invention.

1. A modular element for the manufacturing of an arm or of an arm segment of a spray bar provided with spray nozzles, comprising:
a first profile determining a longitudinal housing open downwards and at each of its longitudinal ends, the first profile and the housing being configured to entirely receive the spray nozzles and pipings connecting them to each other,
a reinforcement disposed above the first profile in such a way that the respective longitudinal axes of the reinforcement and of the first profile belong to the vertical plane P of longitudinal symmetry of said modular element,
a plurality of stiffeners longitudinally connecting at least the first profile and the reinforcement to each other, and
two plates each disposed at one of the longitudinal ends of said first profile and laterally connecting at least the longitudinal ends of the first profile and of the reinforcement to each other.

2. The modular element according to claim 1, further comprising:
a second profile disposed above the reinforcement in such a way that its longitudinal axis belongs to said vertical plane P and in that said reinforcements longitudinally connect the first profile, the reinforcement and the second profile to each other, and said plates laterally connect the longitudinal ends of the first profile, of the reinforcement and of the second profile to each other.

3. The modular element according to claim 1, wherein the first profile has a transverse cross-section in the overall shape of a C pivoted by 90° and comprises a substantially horizontal core, two flanges coming from the longitudinal edges of said core and extending downwards, and two lips each coming from the lower longitudinal edges of said flanges and extending substantially horizontally towards the inside of said flanges while facing each other.

4. The modular element according to claim 2, wherein the first and second profiles are perforated and respectively comprise a plurality of holes.

5. The modular element according to claim 1, wherein the reinforcement has a transverse cross-section having a generally circular shape and is hollow tubular opening at each of its longitudinal ends.

6. The modular element according to claim 5, wherein the reinforcement comprises an orifice made under said reinforcement.

7. The modular element according to claim 1, wherein each plate comprises a plurality of piercings and determines two flat faces parallel to each other and offset with respect to one another and an inclined median face connecting the two flats to each other, said plates having a complementary shape.

8. The modular element according to claim 1, wherein the component elements of the modular element comprise a plurality of orifices (12).

9. A method for manufacturing a modular element according to claim 8, wherein the following is carried out:
manufacturing of the component elements of the element,
preassembly of said component elements using bolts put in place in the orifices, and
welding of said component elements of the element to each other.

10. An arm or of an arm segment of a spray bar manufactured from at least one modular element according to claim 1.
